(19) United States
(12) Patent Application Publication
(10) Pub. No.: US 2025/0331437 A1
(43) Pub. Date: Oct. 30, 2025

(54) VEHICLES, METHODS AND NON-TRANSITORY COMPUTER-READABLE MEDIA FOR REAL-TIME DYNAMIC PATH GENERATION

(71) Applicant: Deere & Company, Moline, IL (US)

(72) Inventors: Eric R. ANDERSON, Ames, IA (US); Michael R. WHITE, Urbandale, IA (US)

(73) Assignee: Deere & Company, Moline, IL (US)

(21) Appl. No.: 18/647,108

(22) Filed: Apr. 26, 2024

(51) Int. Cl. A01B 69/00; G05D 1/686; G05D 105/15

(52) U.S. Cl. CPC A01B 69/007; G05D 1/686; G05D 2105/15

(57) ABSTRACT

Vehicles, methods, and non-transitory computer-readable media are provided for dynamic path generation. A vehicle including a steering mechanism, and processing circuitry configured to cause the follower vehicle to generate a control point based on a first model and location information corresponding to a leader vehicle, the first model corresponding to the follower vehicle, and the location information including a location of the leader vehicle and a heading of the leader vehicle, generate at least a portion of a path based on the control point, the path being toward a first position relative to the leader vehicle, and control a steering angle of the steering mechanism based on the at least the portion of the path.

### FIELD OF THE DISCLOSURE

Some example embodiments provide vehicles, methods, and non-transitory computer-readable media for dynamically generating a trajectory guiding a vehicle to a position relative to another vehicle.

### BACKGROUND

In agricultural and/or industrial operations involving transfer of materials from a first moving vehicle to a second moving vehicle, the vehicles are controlled to maintain a relative distance from one another while the materials are transferred. For example, in operations in which the materials are transferred from the first moving vehicle to the second moving vehicle via an auger of the first moving vehicle, the second moving vehicle is controlled to maintain a specific relative distance from the first moving vehicle that positions the second moving vehicle underneath an outlet of the auger.

### SUMMARY

Some example embodiments provide improved vehicles, methods, and non-transitory computer-readable media for dynamically generating a trajectory guiding a vehicle to a position relative to another vehicle.

Some example embodiments provide a vehicle including a steering mechanism, and processing circuitry configured to cause the follower vehicle to generate a control point based on a first model and location information corresponding to a leader vehicle, the first model corresponding to the follower vehicle, and the location information including a location of the leader vehicle and a heading of the leader vehicle, generate at least a portion of a path based on the control point, the path being toward a first position relative to the leader vehicle, and control a steering angle of the steering mechanism based on the at least the portion of the path.

Some example embodiments provide a method for guiding a follower vehicle including generating a control point based on a first model and location information corresponding to a leader vehicle, the first model corresponding to the follower vehicle, and the location information including a location of the leader vehicle and a heading of the leader vehicle, generating at least a portion of a path based on the control point, the path being toward a first position relative to the leader vehicle, and controlling a steering angle of a steering mechanism of the follower vehicle based on the at least the portion of the path.

Some example embodiments provide a system including a non-transitory computer-readable medium storing instructions that, when executed by at least one processor, cause the at least one processor to perform a method for guiding a follower vehicle, the method including generating a control point based on a first model and location information corresponding to a leader vehicle, the first model corresponding to the follower vehicle, and the location information including a location of the leader vehicle and a heading of the leader vehicle, generating at least a portion of a path based on the control point, the path being toward a first position relative to the leader vehicle, and controlling a steering angle of a steering mechanism of the follower vehicle based on the at least the portion of the path.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For the purposes of clarity, various dimensions of the drawings may have been exaggerated.

FIG. 1 illustrates a plan view of a leader vehicle and a follower vehicle that are aligned for transferring of material from the leader vehicle to the follower vehicle, in accordance with some example embodiments;

FIG. 2 illustrates a diagram of system, according to some example embodiments;

FIG. 3 illustrates an example scenario of a follower vehicle being guided to a position relative to a leader vehicle, according to some example embodiments;

FIG. 4 illustrates an example scenario of a follower vehicle being guided to a position relative to a leader vehicle using a kinematic model, according to some example embodiments; and

FIG. 5 illustrates a method of controlling a follower vehicle, according to some example embodiments.

### DETAILED DESCRIPTION

Some example embodiments described herein relate to transferring or unloading material (e.g., agricultural material) between two vehicles (e.g., moving vehicles). The vehicles may comprise a leader vehicle (e.g., combine or harvesting machine) and follower vehicle (e.g., a combine and grain cart, wagon, etc.) that are both moving. The material may be transferred from the leader vehicle to the follower vehicle via an auger of the leader vehicle. The agricultural material may comprise grain, corn, soybeans, legumes, nuts, vegetables, fruits, potatoes, tubers, oilseeds, fiber and/or other harvested plant material. The material may comprise the agricultural material, minerals, metals, oil, tar sands, shale, raw petroleum products, mined material, ores, soil, sand, clay, stones, crushed rock, gravel, peat, organic matter, animal waste and/or other material.

In operations in which the materials are transferred from the leader vehicle to the follower vehicle via an auger of the leader vehicle, the follower vehicle is controlled to maintain a specific relative distance from the leader vehicle that positions the follower vehicle underneath an outlet of the auger. In some instances, the auger may be 10 meters or more in length. Due to the length of the auger, relatively small changes in motion (e.g., yaw) of the leader vehicle (and/or auger) may result in relatively large changes to a target position of the follower vehicle, relative to the leader vehicle, for maintaining the specific relative distance. Similarly, even smaller errors in detected motion (e.g., yaw noise) of the leader vehicle (and/or auger) may result in relatively large errors in a calculated target position of the follower vehicle.

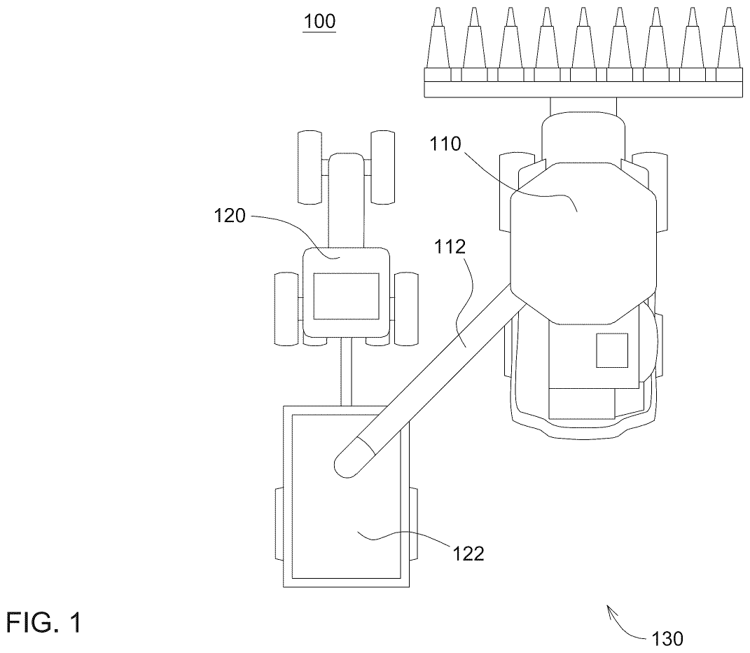

FIG. 1 illustrates a plan view of a leader vehicle and a follower vehicle that are aligned for transferring of material from the leader vehicle to the follower vehicle, in accordance with some example embodiments.

Referring to FIG. 1, a system 100 includes a leader vehicle 110 and a follower vehicle 120, according to some example embodiments. As illustrated in FIG. 1, the leader vehicle 110 is a harvester transferring agricultural material to a wagon, however, some example embodiments are not limited thereto. According to some example embodiments, the leader vehicle 110 and/or the follower vehicle 120 may be implemented by any type of moving vehicle, and the material transferred may include any type of material capable of being transferred according to the example implementations described herein. Also, while FIG. 1 illustrates a pair of vehicles, some example embodiments are not limited thereto. According to some example embodiments, the system 100 may include more than two vehicles transferring material among one another. Also, some example embodiments are not limited to operations involving material transfer between the vehicles. For instance, according to some example embodiments, the vehicles may perform any operation in which relative positions between the vehicles are relevant for coordination among the vehicles. Nonetheless, the example of a pair of vehicles transferring agricultural material will mainly be discussed below for added clarity of description of some example embodiments.

The leader vehicle 110 and the follower vehicle 120 may be moving (e.g., driving) in a generally common (e.g., forward) direction in a work area (e.g., a field) 130. The leader vehicle 110 includes an auger 112 that may transfer the agricultural material to the follower vehicle 120 under the control of the leader vehicle 110. According to some example embodiments, the auger 112 may be 10 meters or more in length, however some example embodiments are not limited thereto. According to some example embodiments, the auger 112 may be a different length. The follower vehicle 120 may include an open container 122 configured to receive the agricultural material from the leader vehicle 110.

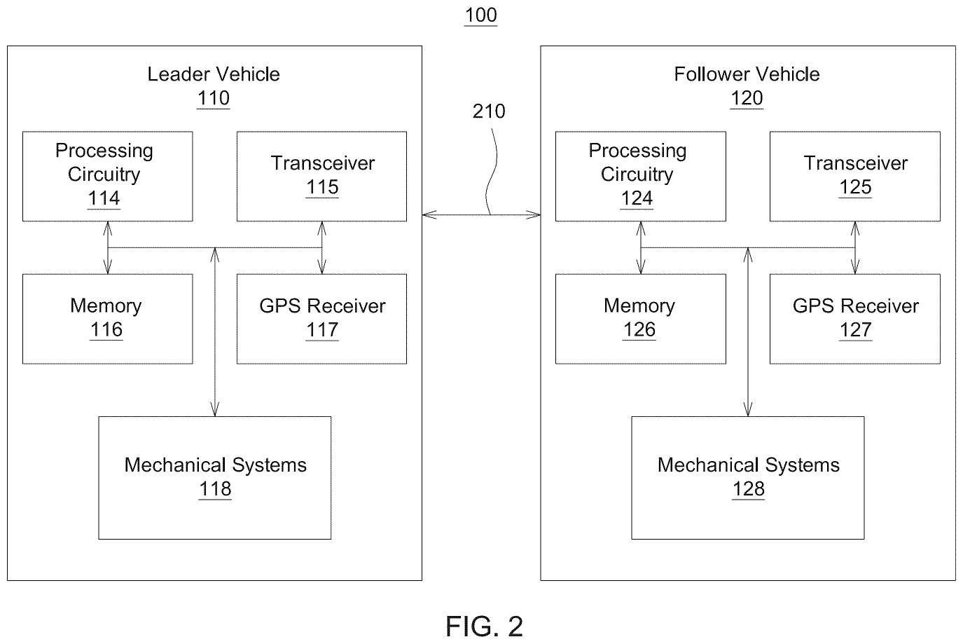

FIG. 2 illustrates a diagram of system 100, according to some example embodiments.

Referring to FIG. 2, the leader vehicle 110 may include processing circuitry 114, a transceiver 115, a memory 116, a Global Positioning System (GPS) receiver 117 and/or mechanical systems 118. The processing circuitry 114 may control overall operation of the leader vehicle 110. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The processing circuitry 114 may store and/or retrieve data to and/or from the memory 116 (e.g., programming instructions for execution by the processing circuitry 114, operational data generated by the processing circuitry 114, etc.). The processing circuitry 114 may receive communication signals from the transceiver 115 and/or provide communication signals to the transceiver 115. The processing circuitry 114 may receive a current position of the leader vehicle 110 from the GPS receiver 117. The processing circuitry 114 may generate and send control signals for controlling the mechanical systems 118.

The transceiver 115 may transmit and/or receive communication signals to and/or from other devices (e.g., the follower vehicle 120). For example, the transceiver 115 may transmit a communication signal to the follower vehicle 120 via a communication link 210 under control of the processing circuitry 114. The communication signal may include a current position (e.g., a most recently detected position) of the leader vehicle 110. The current position may be represented by two-dimensional coordinates (e.g., Northing and Easting) obtained from the GPS receiver 117. According to some example embodiments, the communication signal may also include one or more of a time corresponding to the current position of the leader vehicle 110, a heading of the leader vehicle 110, a velocity of the leader vehicle 110 and/or a yaw rate of the leader vehicle 110. While described as a transceiver capable of both transmitting and receiving herein, some example embodiments are not limited thereto. For example, according to some example embodiments, the transceiver 115 may be a transmitter only capable of transmitting communication signals. According to some example embodiments, the communication link 210 may be a wireless communication link between the leader vehicle 110 and the follower vehicle 120. For example, the wireless communication link 210 may be a Wi-Fi link, however, some example embodiments are not limited thereto. According to some example embodiments, the wireless communication link 210 may be any wireless link (e.g., a cellular link, a satellite link, etc.).

The memory 116 may be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art. The memory 116 may store data and/or instructions for retrieval by, for example, the processing circuitry 114.

The GPS receiver 117 may receive a positioning signal representative of a current position of the leader vehicle 110, and may provide the positioning signal to the processing circuitry 114.

The mechanical systems 118 may include one or more mechanical systems for controlling movement and position of the leader vehicle 110. The mechanical systems 118 may include, for example, a steering mechanism, a propulsion mechanism (e.g., a motor), a breaking mechanism, etc. Each respective mechanical system among the mechanical systems 118 may be controlled according to corresponding control signals received from the processing circuitry 114.

The follower vehicle 120 may include processing circuitry 124, a transceiver 125, a memory 126, a GPS receiver 127 and/or mechanical systems 128. The processing circuitry 124, the transceiver 125, the memory 126, the GPS receiver 127 and/or the mechanical systems 128 may be the same as, or similar to, the processing circuitry 114, the transceiver 115, the memory 116, the GPS receiver 117 and/or the mechanical systems 118, respectively, and redundant description may be omitted.

The processing circuitry 124 may control overall operations of the follower vehicle 120. The processing circuitry 124 may receive a current position of the follower vehicle 120 from the GPS receiver 127. The transceiver 125 may transmit and/or receive communication signals to and/or from other devices (e.g., the leader vehicle 110). For example, the transceiver 125 may receive a communication signal from the leader vehicle 110 via the communication link 210 under control of the processing circuitry 124. The communication signal may include a current position (e.g., a most recently detected position) of the leader vehicle 110. According to some example embodiments, the communication signal may also include one or more of a time corresponding to the current position of the leader vehicle 110, a heading of the leader vehicle 110, a velocity of the leader vehicle 110 and/or a yaw rate of the leader vehicle 110. While described as a transceiver capable of both transmitting and receiving herein, some example embodiments are not limited thereto. For example, according to some example embodiments, the transceiver 115 may be a receiver only capable of receiving communication signals.

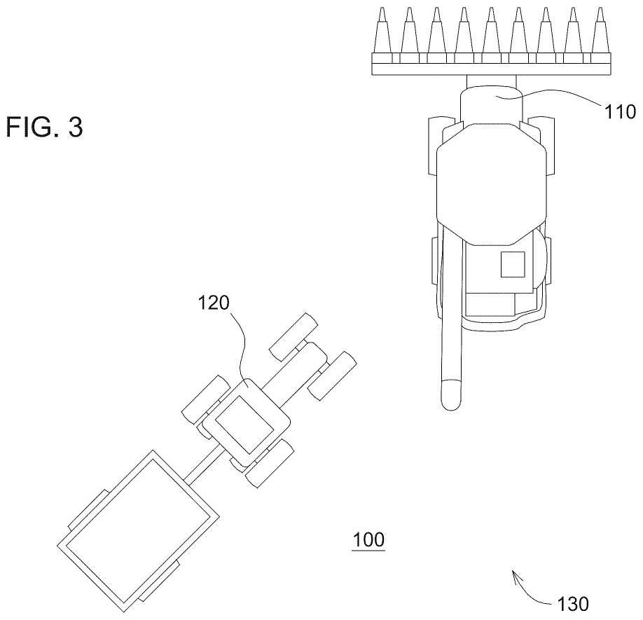

FIG. 3 illustrates an example scenario of a follower vehicle being guided to a position relative to a leader vehicle, according to some example embodiments.

Referring to FIG. 3, in an example scenario, the leader vehicle 110 (e.g., a harvester) may be traveling in a first direction in a work area 130 (e.g., a field). In order to enable the follower vehicle 120 to receive material (e.g., harvested agricultural material) from the leader vehicle 110 while the leader vehicle 110 continues to travel (and harvest), the follower vehicle 120 may be guided to a position relative to the leader vehicle 110 (also referred to herein as the “first position”). According to some example embodiments, the first position may be a position at which an outlet of the auger 112 is positioned over the open container 122. However, some example embodiments are not limited thereto, and the first position may be any position relative to the leader vehicle 110 that permits the transfer of material from the leader vehicle 110 to the follower vehicle 120 while both the leader vehicle 110 and the follower vehicle are moving (e.g., both moving in the first direction). Also, in implementations in which the operations performed do not involve material transfer, the first position may be any position (e.g., any defined position) relative to the leader vehicle 110 sufficient to enable the performance of the operations. As should be understood, since the first position is a position relative to the leader vehicle 110, a geographic location of the first position may change as the leader vehicle 110 travels.

According to some example embodiments, the first position may be defined by one or more offsets, for example, a first offset in the direction of travel of the leader vehicle 110 (also referred to herein as a “first direction”) and/or a second offset in a direction perpendicular to the direction of travel of the leader vehicle 110 (also referred to herein as a “second direction”). According to some example embodiments, the first position (and/or the first and second offsets) may be associated with at least one distance in at least one direction (e.g., the first direction and/or the second direction). The at least one distance may correspond to an amount of deviation from the first position in the at least one direction in which the transfer of material from the leader vehicle 110 to the follower vehicle 120 may still be performed. For example, the first position may correspond with a relative positioning placing the outlet of the auger 112 over a center position of the open container 122. In this example, the at least one distance may include a first distance in the first direction and a second distance in the second direction generally corresponding to length and width dimensions, respectfully, of the open container 122. As such, according to some example embodiments, the first position may be considered a first region defined by the first and second distances measured from the first position.

Conventional devices and methods for guiding a follower vehicle to a specific position relative to a moving leader vehicle involve the follower vehicle receiving position data of the leader vehicle, predicting a current position of the leader vehicle based on the position data (may also be referred to herein as “latency recovery”), and adjusting a steering angle and/or speed of the follower vehicle towards the specific position (e.g., using a Proportional, Integral and Derivative (PID) algorithm). However, due to delay occurring between the measurement of the position data of the leader vehicle (e.g., by a GPS receiver on the leader vehicle), the communication of the position data to the follower vehicle, and the prediction of the current position of the leader vehicle, the position of the leader vehicle may have changed and may be predicted by the follower vehicle, a process that introduces error and/or noise. For instance, if the leader vehicle is traveling at 3 meters per second, the follower vehicle may predict the position of the leader vehicle as much as 0.9 meters ahead.

For example, the error and/or noise may be based on inaccuracy in the predicted position of the leader vehicle, false indications that the leader vehicle is turning (e.g., yaw noise), etc. In implementations in which the material is transferred to the follower vehicle via an auger, small errors in leader vehicle heading and yaw rate may result in large inaccuracies in the path generated for the follower vehicle due to, for example, the length of the auger.

Due to the above-described error and/or noise, the conventional devices and methods that adjust the steering angle and/or speed of the follower vehicle based on the predicted positions of the leader vehicle may result in harsh commands (e.g., due to inconsistent yaw rates, headings, etc.), resulting in vehicle motion that is uncomfortable for the driver and/or passengers. For example, in each successive iteration of the above-described process performed by the conventional devices and methods, the follower vehicle adjusts its steering angle and/or speed in a direction determined based on the prediction of the position of the leader vehicle. As this predicted position changes in successive iterations due to error and/or noise the resulting steering angle and/or speed adjustments may vary harshly in both magnitude and direction. Such harsh commands result in even greater discomfort for the driver and/or passengers in implementations in which the follower vehicle is an articulated machine in which cases the hard steering actions directly create lateral accelerations of a cab of the articulated machine.

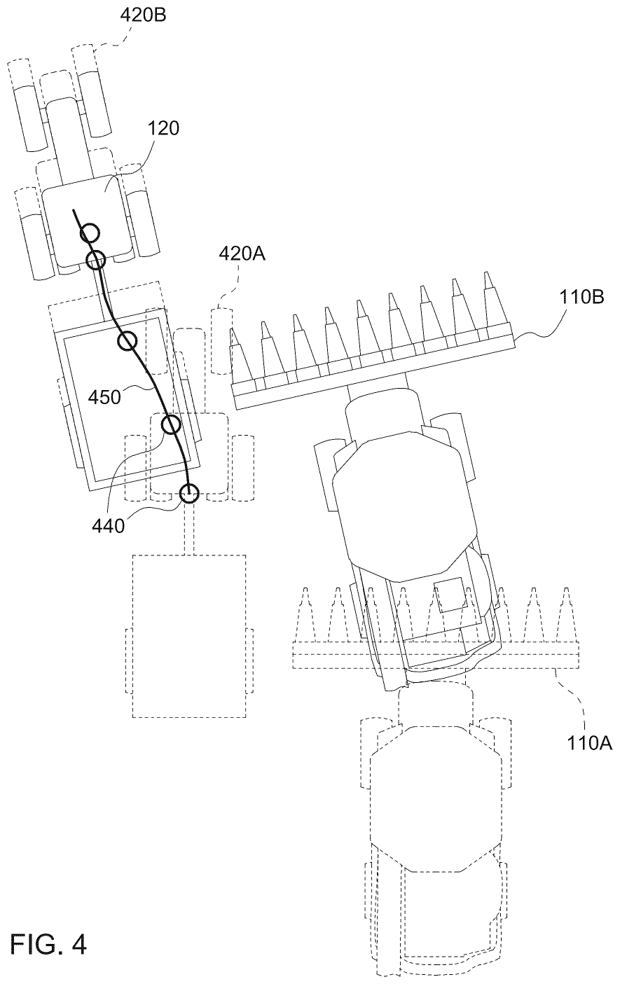

FIG. 4 illustrates an example scenario of a follower vehicle being guided to a position relative to a leader vehicle using a kinematic model, according to some example embodiments.

Referring to FIG. 4, the follower vehicle 120 may be guided to the first position while the leader vehicle 110 continues to travel (and, in some cases, continues to harvest), similar to the illustration of FIG. 3. However, as discussed further below, some example embodiments are provided that provide improved devices and methods that overcome the above-described deficiencies of the conventional devices and methods by, for example, providing a path that the follower vehicle 120 is able to follow, and that avoids or reduces the above-described harsh commands.

According to some example embodiments, the processing circuitry 124 of the follower vehicle 120 may receive location and/or trajectory information transmitted (e.g., broadcasted) by the leader vehicle 110 (e.g., via the communication link 210). The leader vehicle 110 may transmit this information continuously and/or periodically. The location and/or trajectory information may include at least one among a current location of the leader vehicle 110 (e.g., Northing and Easting), a heading of the leader vehicle 110, a yaw rate of the leader vehicle 110, a speed of the leader vehicle 110 and/or a time corresponding to the location and/or trajectory information (e.g., a time at which the information was detected and/or current).

The processing circuitry 124 may use the location and/or trajectory information to predict a current location and/or trajectory of the leader vehicle 110 (depicted in FIG. 4 as the leader vehicle 110B). For example, the location and/or trajectory information received from the leader vehicle 110 may represent the location and/or trajectory of the leader vehicle 110 at a first time (depicted in FIG. 4 as the leader vehicle 110A), and the processing circuitry 124 may predict a current location and/or trajectory (e.g., the location and/or trajectory of the leader vehicle 110 at a second time subsequent to the first time (e.g., the leader vehicle 110B)) of the leader vehicle based on the location and/or trajectory information. According to some example embodiments, the processing circuitry 124 may predict the current location and/or trajectory of the leader vehicle 110 using extrapolation and/or a Kalmann filter. However, some example embodiments are not limited thereto. According to some example embodiments, the processing circuitry 124 may predict the current location and/or trajectory of the leader vehicle 110 using any process known in the art. According to some example embodiments, the processing circuitry 124 may determine the first position based on the current location and/or trajectory of the leader vehicle 110, for example, based on the one or more offsets from the current location and/or trajectory of the leader vehicle 110 discussed above.

The processing circuitry 124 may generate a control point 440 based on the prediction of the current location and/or trajectory of the leader vehicle 110 using a kinematic model corresponding to the follower vehicle 120. For example, the kinematic model may be a bicycle model having a rigid body, front wheel steering, fixed rear wheels (e.g., no steering of rear wheels) and/or having a wheelbase of fixed dimensions as may be consistent with the characteristics of the follower vehicle 120. That is, the follower vehicle 120 may likewise have a rigid body, front wheel steering and fixed rear wheels, and the fixed dimensions of the wheelbase in the bicycle model may be configured to have the dimensions of the wheelbase of the follower vehicle 120. While the kinematic model is described herein as being a bicycle model, some example embodiments are not limited thereto. For example, the other kinematic models may be used representing characteristics of other types of follower vehicles 120, such as Ackermann-steered vehicles, articulated vehicles, differentially-steered vehicles, vehicles having four-wheel steering (or steered by more than four wheels), etc. According to some example embodiments, the above constraints of the kinematic model limit (and/or filter) possible paths that may be generated for the follower vehicle 120 to those consistent with the characteristics of the follower vehicle 120, thereby ensuring and/or improving the likelihood that paths generated for the follower vehicle 120 will be paths that the follower vehicle 120 is capable (e.g., physically capable) of following.

The processing circuitry 124 may use the kinematic model to iteratively generate a next control point for use in plotting a path 450 guiding the follower vehicle 120 to the first position. This process may be conceptualized using a virtual vehicle (depicted in FIG. 4 as both the virtual vehicle 420A and the virtual vehicle 420B, referred to collectively herein as the virtual vehicle 420) representing the kinematic model. The kinematic model may be initialized with values for the virtual vehicle 420 that are consistent with current operating parameters of the follower vehicle 120. For example, these current operating parameters may include a current steering angle, a current velocity (and/or speed), etc. According to some example embodiments, the current operating parameters of the follower vehicle 120 may include at least one of a respective position (e.g., Northing and Easting), a heading, a velocity (and/or speed), a yaw rate, a steering angle and/or a time corresponding to the current operating parameters of the follower vehicle 120 (e.g., a time at which the remaining current operating parameters are accurate). According to some example embodiments, parameters and/or parameter values of the kinematic model may only be adjusted to reflect current operating parameters of the follower vehicle 120 during initialization, and the processing circuitry 124 may only further adjust these parameters and/or parameter values based on the determined control points 440 described below. However, some example embodiments are not limited thereto. For example, the parameters and/or parameter values of the kinematic model corresponding to the current velocity (and/or speed) of the follower vehicle 120 may be updated (e.g., by the processing circuitry 124) on each iteration.

The processing circuitry 124 may iteratively generate a next control point 440 for the virtual vehicle 420 based on the location and/or trajectory information received from the leader vehicle 110. According to some example embodiments, in each iteration of the process, the processing circuitry 124 may obtain updated location and/or trajectory information from the leader vehicle 110, and use the updated location and/or trajectory information to predict a current location and/or trajectory of the leader vehicle 110, for example, according to the approach discussed above. This current location and/or trajectory of the leader vehicle 110 may also be referred to herein as a forecasted data point (e.g., a next forecasted data point). Each of the forecasted data points may include at least one of a respective position (e.g., Northing and Easting), a heading, a velocity (and/or speed), a yaw rate and/or a time corresponding to the forecasted data point (e.g., a time at which the values for the respective position, heading, velocity (and/or speed), and/or yaw rate are predicted to be current).

The processing circuitry 124 may generate a next control point 440 based on the next forecasted data point. For example, the processing circuitry 124 may determine an error (e.g., a lateral error) between current location and/or trajectory information of the virtual vehicle 420 and the first position. The error (e.g., the lateral error) may represent the distance between the current position of the virtual vehicle 420 and the first position. This distance may be represented in one dimension (e.g., lateral error) or in two or more dimensions (e.g., heading error, inline error, etc.). In a first iteration, the current location and/or trajectory information may refer to the current operating parameters of the follower vehicle 120 used to initialize the kinematic model. In iterations subsequent to the first iteration, the current location and/or trajectory information may refer to a most recently determined control point 440. As such, in iterations subsequent to the first iteration, the virtual vehicle 420 may be considered to have driven to the most recently determined control point 440 (depicted in FIG. 4 as the virtual vehicle 420B) from a previously determined control point 440 (depicted in FIG. 4 as the virtual vehicle 420A), and the error to the first position would be determined from that most recently determined control point 440.

According to some example embodiments, the processing circuitry 124 may determine an adjusted steering angle for the virtual vehicle 420 based on the determined error (e.g., lateral error) and the kinematic model (e.g., according to the constraints of the kinematic model such that the resulting steering angle is one of which the follower vehicle 120 is capable). For example, the processing circuitry 124 may determine the adjusted steering angle for the virtual vehicle 420 based on the lateral error using the bicycle model, but some example embodiments are not limited thereto. According to some example embodiments, the processing circuitry 124 may determine the adjusted steering angle, based on the determined error (e.g., lateral error) and the kinematic model, using a PID algorithm. According to some example embodiments, the processing circuitry 124 may determine both the adjusted steering angle and an adjusted speed for the virtual vehicle 420, but some example embodiments are not limited thereto. According to some example embodiments, the processing circuitry 124 may only determine the adjusted steering angle without determining the adjusted speed for the virtual vehicle 420.

The processing circuitry 124 may generate (e.g., calculate, determine, etc.) a next control point 440 based on the determined adjusted steering angle (and the adjusted speed if applicable) and the remaining current location and/or trajectory information of the virtual vehicle 420. Each of the control points 440 may include at least one of a respective position (e.g., Northing and Easting), a heading, a velocity (and/or speed), yaw rate, a steering angle and/or a time corresponding to the control point 440. According to some example embodiments, the processing circuitry 124 may calculate the next control point 440 at some fixed (or alternatively, given) time interval from the previous control point 440 (or from the time corresponding to the current operating parameters of the follower vehicle 120 in the first iteration). The fixed (or alternatively, given) time interval may be equal to, similar to, or based on (1) the time interval between each iteration at which the next control point 440 is calculated, (2) the time interval representing the delay between when the leader vehicle 110 determines its position and when the processing circuitry 124 predicts the current location and/or trajectory of the leader vehicle 110, or (3) another time interval. According to some example embodiments, in addition to the determined steering angle adjustment and remaining current location and/or trajectory information of the virtual vehicle 420, the processing circuitry 124 may generate the next control point based on other contextual information (e.g., a current location of the virtual vehicle 420 relative to the leader vehicle 110 and/or a current location of the virtual vehicle relative to a crop row). According to some example embodiments, the time corresponding to the control point 440 may be used to coordinate and/or synchronize multi-vehicle operations (e.g., more than two vehicles). For example, such applications may involve multiple follower vehicles 120 and/or vehicle swarms. In such applications, overlapping trajectories that are temporally distinct may be used to avoid or reduce collisions.

The processing circuitry 124 may generate (e.g., calculate, determine, etc.) a next path segment in the path 450 based on current operating parameters of the follower vehicle 120 (e.g., at least one of a position (e.g., Northing and Easting), a heading, a velocity (and/or speed), yaw rate and/or a steering angle) and the next control point 440. According to some example embodiments, the processing circuitry 124 does not determine a path segment of the path 450 in the first iteration, but only in each iteration subsequent to the first iteration. The processing circuitry 124 may determine the next path segment such that the path 450 is continuous, and avoids or reduces the occurrence/severity of harsh commands. According to some example embodiments, the processing circuitry 124 may generate the next path segment using a pure pursuit controller as would be known to persons having ordinary skill in the art, but some example embodiments are not limited thereto. According to some example embodiments, the processing circuitry 124 may apply a trapezoidal rule to smooth the path segment in order to remove or reduce harsh commands. However, some example embodiments are not limited thereto. According to some example embodiments, the processing circuitry 124 may determine the path segment to avoid (or reduce) steering angle changes beyond a threshold level determined through empirical study to be associated with driver discomfort. The threshold level may vary according to a current speed of the follower vehicle 120. Accordingly, the processing circuitry 124 may iteratively compute a next control point for moving the virtual vehicle 420, and then compute a path segment to be followed by the follower vehicle 120 based on the movement of the virtual vehicle 420.

The processing circuitry 124 may control the follower vehicle 120 to follow the next path segment. For example, the processing circuitry 124 may control a steering mechanism and/or a propulsion mechanism to change a steering angle and/or a velocity of the follower vehicle 120 according to the next path segment. According to some example embodiments, the processing circuitry 124 may control only the steering mechanism to change the steering angle of the follower vehicle 120 without controlling the propulsion mechanism to change the velocity of the follower vehicle 120. In such examples, the velocity of the follower vehicle 120 may be controlled using a PID algorithm.

The above-described process may be repeatedly performed (e.g., in real-time) to bring the follower vehicle 120 to the first position and/or maintain the relative position of the follower vehicle 120 to remain at the first position. The length of the next path segment iteratively computed (and/or the periodicity at which the location and/or trajectory information is transmitted by the leader vehicle 110) may be sufficiently short to permit a generation of continuously curved path 450 without accounting for terrain of the work area 130 and/or the speed of the follower vehicle 120. For example, if the leader vehicle 110 is moving at 3 meters per second, the next path segment may be 0.9 meters ahead. According to some example embodiments, the memory 126 may include at least one moving buffer to which computed path segments may be stored, and from which the computed path segments may be read by the processing circuitry 124 for use in navigation.

According to some example embodiments, the lateral error may be prioritized when the follower vehicle 120 is farther from the first position. Accordingly, the processing circuitry may weigh the lateral error more heavily in determining changes to steering angles in connection with calculation of the next control point and/or determination of the next path segment. As lateral error decreases priority may shifts away from eliminating lateral error and towards solving the heading error. Accordingly, once the lateral error drops below a threshold level, the processing circuitry may weigh the heading error more heavily in determining changes to steering angles in connection with calculation of the next control point and/or determination of the next path segment. According to some example embodiments, the changes to the velocity (and/or speed) may be based only on inline error.

According to some example embodiments, to activate the path generation function of the follower vehicle 120, an operator of the follower vehicle 120 (e.g., a driver) may interact with a corresponding user interface of the follower vehicle 120 (e.g., an interface in a cab of the follower vehicle). Similarly, the operator may deactivate the path generation function via a corresponding user interface of the follower vehicle 120.

Through the use of the kinematic model (e.g., bicycle model), the processing circuitry 124 may generate a path 450 that is always (and/or likely) navigable by the follower vehicle 120, and/or continuous in curvature, in contrast to that generated by the conventional devices and methods. Also, according to some example embodiments, the kinematic model may be configured with further constraints regarding changes in curvature of the path and/or changes in speed. Accordingly, the processing circuitry 124 may also generate a path 450 that always (and/or likely) provides for driver and/or passenger comfort by eliminating (and/or reducing) harsh commands, in contrast to that generated by the conventional devices and methods. Therefore, the improved devices and methods provided according to some example embodiments overcome the deficiencies of the conventional devices and methods to at least generate a more navigable and comfortable path for guiding the follower vehicle 120 to the first position. Also, the computations performed using the kinematic model are less complex than those performed by the conventional devices and methods, and thus, the improved devices and methods reduce delay and resource consumption (e.g., processor, memory, power, etc.).

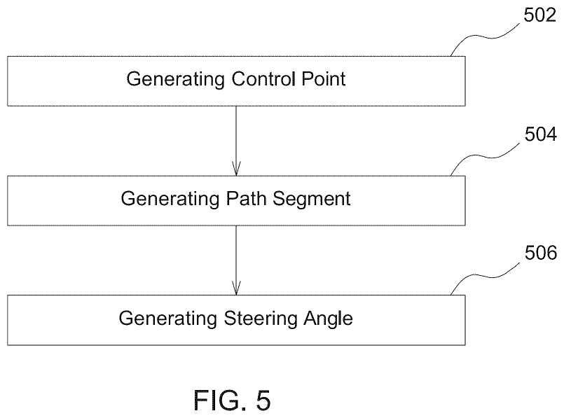

Referring to FIG. 5 illustrates a method of controlling a follower vehicle, according to some example embodiments. According to some example embodiments, the method may be performed by the processing circuitry 124.

Referring to FIG. 5, in operation 502, the method may include generating a control point based on a first model and location information corresponding to a leader vehicle. The location information may correspond to, for example, the location and/or trajectory information received from the leader vehicle 110. According to some example embodiments, the first model may correspond to, for example, the above-described kinematic model.

In operation 504, the method may include generating at least a portion of a path based on the control point. According to some example embodiments, operation 504 may include generating a control point 440 based on a forecasted data point, and generating the path segment based on the control point 440 as discussed further above.

In operation 506, the method may include controlling a steering angle of a steering mechanism of the follower vehicle 120 based on at least the portion of the path. As discussed above, operations 502, 504 and 506 may be performed iteratively to bring the follower vehicle 120 to the first position and/or to maintain a position of the follower vehicle 120 as the first position.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with some example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 116 and the memory 126).

According to some example embodiments, the memory 116 and the memory 126 may each be a tangible, non-transitory computer-readable medium, such as a Random Access Memory (RAM), a flash memory, a Read Only Memory (ROM), an Electrically Programmable ROM (EPROM), an Electrically Erasable Programmable ROM (EEPROM), registers, a hard disk, a removable disk, a Compact Disk (CD) ROM, any combination thereof, or any other form of storage medium known in the art.

Some example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

It will be understood that when an element is referred to as being “connected” or “coupled” to another element, it may be directly connected or coupled to the other element or intervening elements may be present. As used herein the term “and/or” includes any and all combinations of one or more of the associated listed items.

Although terms of “first” or “second” may be used to explain various components (or parameters, values, etc.), the components (or parameters, values, etc.) are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

1. A follower vehicle, comprising:
a steering mechanism; and
processing circuitry configured to cause the follower vehicle to
generate a control point based on a first model and location information corresponding to a leader vehicle, the first model corresponding to the follower vehicle, and the location information including a location of the leader vehicle and a heading of the leader vehicle,
generate at least a portion of a path based on the control point, the path being toward a first position relative to the leader vehicle, and
control a steering angle of the steering mechanism based on the at least the portion of the path.

2. The follower vehicle of claim 1, wherein the first position is a position relative to the leader vehicle at which the follower vehicle receives material transferred from the leader vehicle while the leader vehicle is traveling.

3. The follower vehicle of claim 2, wherein
the leader vehicle is a harvester; and
the first position is a position relative to the leader vehicle at which the follower vehicle receives agricultural material transferred from the leader vehicle while the leader vehicle is harvesting.

4. The follower vehicle of claim 1, wherein the path is a continuous curve.

5. The follower vehicle of claim 1, wherein
the first model is a kinematic model;
the kinematic model is a bicycle model corresponding to a rigid body and front wheel steering; and
the follower vehicle has a rigid body and front wheel steering.

6. The follower vehicle of claim 1, wherein
the first model is a kinematic model; and
the kinematic model defines dimensions of a wheelbase consistent with dimensions of a wheelbase of the follower vehicle.

7. The follower vehicle of claim 1, wherein
the first model is a kinematic model; and
one of
the kinematic model is a model of an Ackermann-steered vehicle and the follower vehicle is an Ackermann-steered vehicle,
the kinematic model is a model of an articulated vehicle and the follower vehicle is an articulated vehicle, or
the kinematic model is a model of a differentially-steered vehicle and the follower vehicle is a differentially-steered vehicle.

8. A method for guiding a follower vehicle, comprising:
generating a control point based on a first model and location information corresponding to a leader vehicle, the first model corresponding to the follower vehicle, and the location information including a location of the leader vehicle and a heading of the leader vehicle;
generating at least a portion of a path based on the control point, the path being toward a first position relative to the leader vehicle; and
controlling a steering angle of a steering mechanism of the follower vehicle based on the at least the portion of the path.

9. The method of claim 8, wherein the first position is a position relative to the leader vehicle at which the follower vehicle receives material transferred from the leader vehicle while the leader vehicle is traveling.

10. The method of claim 9, wherein
the leader vehicle is a harvester; and
the first position is a position relative to the leader vehicle at which the follower vehicle receives agricultural material transferred from the leader vehicle while the leader vehicle is harvesting.

11. The method of claim 8, wherein the path is a continuous curve.

12. The method of claim 8, wherein
the first model is a kinematic model;
the kinematic model is a bicycle model corresponding to a rigid body and front wheel steering; and
the follower vehicle has a rigid body and front wheel steering.

13. The method of claim 8, wherein
the first model is a kinematic model; and
the kinematic model defines dimensions of a wheelbase consistent with dimensions of a wheelbase of the follower vehicle.

14. The method of claim 8, wherein
the first model is a kinematic model; and
one of
the kinematic model is a model of an Ackermann-steered vehicle and the follower vehicle is an Ackermann-steered vehicle,
the kinematic model is a model of an articulated vehicle and the follower vehicle is an articulated vehicle, or
the kinematic model is a model of a differentially-steered vehicle and the follower vehicle is a differentially-steered vehicle.

15. A non-transitory computer-readable medium storing instructions that, when executed by at least one processor, cause the at least one processor to perform a method for guiding a follower vehicle, the method comprising:
generating a control point based on a first model and location information corresponding to a leader vehicle, the first model corresponding to the follower vehicle, and the location information including a location of the leader vehicle and a heading of the leader vehicle;
generating at least a portion of a path based on the control point, the path being toward a first position relative to the leader vehicle; and
controlling a steering angle of a steering mechanism of the follower vehicle based on the at least the portion of the path.

16. The non-transitory computer-readable medium of claim 15, wherein the first position is a position relative to the leader vehicle at which the follower vehicle receives material transferred from the leader vehicle while the leader vehicle is traveling.

17. The non-transitory computer-readable medium of claim 16, wherein
the leader vehicle is a harvester; and
the first position is a position relative to the leader vehicle at which the follower vehicle receives agricultural material transferred from the leader vehicle while the leader vehicle is harvesting.

18. The non-transitory computer-readable medium of claim 15, wherein the path is a continuous curve.

19. The non-transitory computer-readable medium of claim 15, wherein
the first model is a kinematic model;
the kinematic model is a bicycle model corresponding to a rigid body and front wheel steering; and
the follower vehicle has a rigid body and front wheel steering.

20. The non-transitory computer-readable medium of claim 15, wherein
the first model is a kinematic model; and
the kinematic model defines dimensions of a wheelbase consistent with dimensions of a wheelbase of the follower vehicle.
